(19) United States
(12) Patent Application Publication
(10) Pub. No.: US 2009/0056662 A1
(43) Pub. Date: Mar. 5, 2009

(54) Externally Vented Carburetor System with Vapor Containment

(76) Inventors: Nathan R. Vogt, Elkhart Lake, WI (US); Eric B. Hudak, Sheboygan, WI (US); Gary Stenz, Mount Calvary, WI (US)

Correspondence Address: WHYTE HIRSCHBOECK DUDEK S C;INTELLECTUAL PROPERTY DEPARTMENT, 555 EAST WELLS STREET, SUITE 1900, MILWAUKEE, WI, 53202, US

(21) Appl. No.: 12/204,033

(22) Filed: Sep. 4, 2008

Related U.S. Application Data
(60) Provisional application No. 60/969,815, filed on Sep. 4, 2007.

(51) Int. Cl. F02N 17/00

(52) U.S. Cl. 123/179.9

(57) ABSTRACT

A primer assembly is provided for use on a carburetor that is vented through an external vent on the primer. In at least some embodiments, the assembly comprises a housing comprising an open end and an outlet with a flexible primer bulb inserted into and closing the open end of the housing, thereby defining a volume within the housing. There is a vent in the primer bulb. A carbon canister is positioned within the volume defined in the housing such that the vent and the outlet are in fluid communication via a flow path that extends through the canister. The carbon canister adsorbs fuel vapors from the carburetor. During normal operation of the engine, air enters through the primer vent and purges the carbon canister of the adsorbed fuel.

### CROSS-REFERENCE TO RELATED APPLICATIONS

This application claims the benefit of U.S. provisional patent application No. 60/969,815 entitled “Primer System With Actively Purged Carbon Canister” filed on Sep. 4, 2007, which is hereby incorporated by reference herein.

### FIELD OF THE INVENTION

The present invention relates to internal combustion engines and, more particularly, to carburetors and associated air intake components employed in internal combustion engines.

### BACKGROUND OF THE INVENTION

Small internal combustion engines are used in a wide variety of applications including for example, lawn mowers, lawn tractors, snow blowers and power machinery. Commonly, such internal combustion engines employ a carburetor to provide an appropriate air-fuel mixture to the combustion chamber of the internal combustion engine for generating power. Frequently, such carburetors have a fuel bowl that is coupled to a narrow throat/venturi region of the carburetor that serves as the air-fuel mixing chamber of the carburetor, and fuel enters the carburetor from the fuel bowl due at least in part to pressure differentials occurring within the venturi region.

Many such engines are used in seasonal machines (e.g., lawnmowers, snow blowers, tillers) Or other machines that are not operated for long periods of time (e.g., chain saws), or that are operated under low-temperature conditions. When an engine is cold and/or has not been operated for a long period of time, it can be difficult to start the engine. Additionally, even after the engine has been started, the engine may not run smoothly until the engine warms up. To enhance the performance of such engines under these operational conditions, many engines include an engine priming mechanism by which, to achieve enhanced engine performance, the carburetor is provided with a richer air-fuel mixture.

To prime the carburetor, most carburetors in traditional schemes have a fitting that is pressed or screwed into the carburetor body. The fitting is further connected to passages leading to the fuel bowl attached to the carburetor, with the passages typically being cast or drilled into the carburetor body. Additionally, the primer fitting typically receives at its opposite end (opposite to the end that fits into the carburetor) a primer tube, which can either be directly connected to a primer bulb or lead to another location on the engine at which such a bulb or other priming device is located. More particularly, when a user presses the primer bulb, air is delivered from the priming bulb through the primer tube, the primer fitting and the passages within the carburetor body to the carburetor fuel bowl, and the resulting air pressure increase within the fuel bowl causes fuel to be driven into the carburetor venturi. Depending upon the embodiment, the priming bulb can provide a bowl vent (e.g., by including a small hole within the priming bulb) all by itself or in combination with additional passage(s).

Although adequate in many circumstances, such conventional priming mechanisms nevertheless are inadequate in some regards. A problem with the venting the carburetor through the priming bulb is that it provides no evaporative emissions controls for the hydrocarbons from the fuel in the carburetor bowl. This method will not meet carburetor evaporative emissions regulations for Class I walk-behind engines. For at least these reasons, therefore, it would be advantageous if an improved priming mechanism could be designed.

### BRIEF SUMMARY OF THE INVENTION

In at least one embodiment, the present invention relates to a primer assembly. The primer assembly includes a housing comprising an open end and an outlet. The primer assembly further includes a primer actuation mechanism inserted into and closing the open end of the housing, thereby defining a volume within the housing. Additionally, the primer assembly includes a vapor containment element positioned within the volume defined in the housing. Further, the primer assembly includes a vent formed within either the housing or the primer actuation mechanism, where the vent leads between the volume and a region external of the housing, where the vent and the outlet are in fluid communication via a flow path that extends through the vapor containment element.

Additionally, in at least some embodiments, the present invention relates to a carburetor priming system. The system includes a carburetor adapted to introduce fuel into air that is being drawn into an engine such that a predetermined fuel to air ratio is maintained, the carburetor being further adapted to introduce an extra amount of fuel into the air, such that the fuel to air ratio is higher than the predetermined ratio, in response to the action of a primer. Further, the system includes a primer assembly comprising a housing comprising an open end and an outlet, a primer actuation mechanism inserted into and closing the open end of the housing, thereby defining a volume within the housing, a vapor containment device positioned within the volume defined in the housing, and a vent extending through either the primer actuation mechanism or the housing, wherein the vent and the outlet are in fluid communication via a flow path that extends through the vapor containment device. Also, the system includes a conduit providing fluid communication between the outlet and the airspace above a fuel level in a reservoir of fuel associated with the carburetor.

Additionally, in at least some embodiments the present invention relates to a method for reducing fuel emissions from a carburetor that is externally vented through a primer. The method includes providing a primer assembly comprising a housing comprising an open end and an outlet, a primer actuation mechanism inserted into and closing the open end of the housing, thereby defining a volume within the housing, a vapor containment element positioned within the volume defined in the housing, and a vent extending through either the primer actuation mechanism or the housing, where the vent and the outlet are in fluid communication via a flow path that extends through the vapor containment element. The method also includes connecting the primer in fluid communication with the carburetor such that fuel vapors from the carburetor enter the vapor containment element, and adsorbing the fuel vapors in the vapor containment element.

Further, in at least some embodiments, the present invention relates to a carburetor system that includes a carburetor and a fuel bowl having an airspace above a fuel level, where the airspace is coupled to the carburetor for communication of vapors therebetween by way of a first channel. The carburetor system additionally includes a vapor containment device having first and second ports, and a second channel linking the first port of the vapor containment device at least indirectly to the airspace for further communication of the vapors between the fuel bowl and the vapor containment device, where the second port of the vapor containment device is in direction communication with an external environment outside of the carburetor system.

### BRIEF DESCRIPTION OF THE DRAWINGS

FIG. 1 shows a schematic view of a primer assembly, a carburetor and an intake manifold mounted on an internal combustion engine, and further shows in phantom several different manners of linking the primer assembly with the carburetor and intake manifold in accordance with at least some different embodiments of the present invention;

FIGS. 2A-2D are four flow diagrams illustrating, in schematic form, four different manners of venting/purging the primer assembly of FIG. 1 by way of the four different manners of linking the primer assembly with the carburetor and intake manifold shown in FIG. 1;

FIG. 3 is a schematic, partially cut-away view of one embodiment of a primer assembly and a carburetor in accordance with at least one embodiment of the present invention;

FIG. 4 is a side angle view of the assembled primer assembly of FIG. 3;

FIG. 5 is a cut-away view of the canister housing of the primer assembly of FIG. 3;

FIG. 6 shows the primer assembly of FIG. 3 including the canister housing as attached to an engine housing; and

FIGS. 7 and 8 show schematic, cross-sectional views of other types of primer assemblies differing from that of FIGS. 3-6, in accordance with certain exemplary alternate embodiments of the present invention.

### DETAILED DESCRIPTION OF THE INVENTION

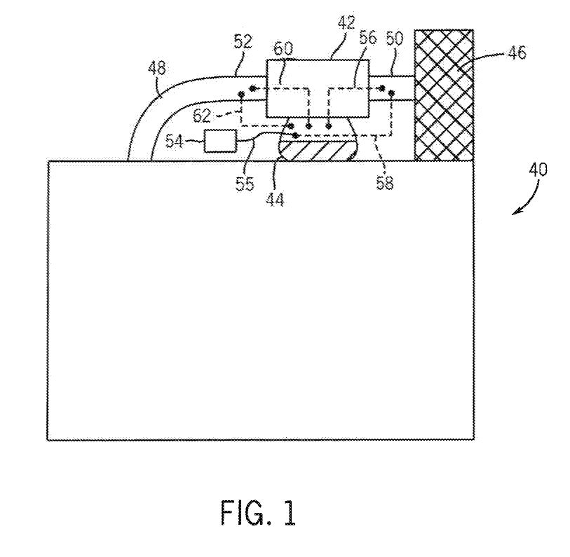

Embodiments of the present invention relate to various types of primer systems that can be implemented in conjunction with a variety of different types of internal combustion engines including, for example, vertical and horizontal crankshaft four cycle internal combustion engines. Referring to FIG. 1, an internal combustion engine 40 is shown to have mounted thereon (and to include) a carburetor 42 having a fuel bowl 44, an air filter 46 and an intake manifold 48. As shown, an inlet 50 of the carburetor 42 is coupled to an air filter 46 that receives air from the outside atmosphere, and an outlet 52 of the carburetor is shown to be coupled to the intake manifold 48, which leads to the remainder of the engine (e.g., to one or more cylinders of the engine).

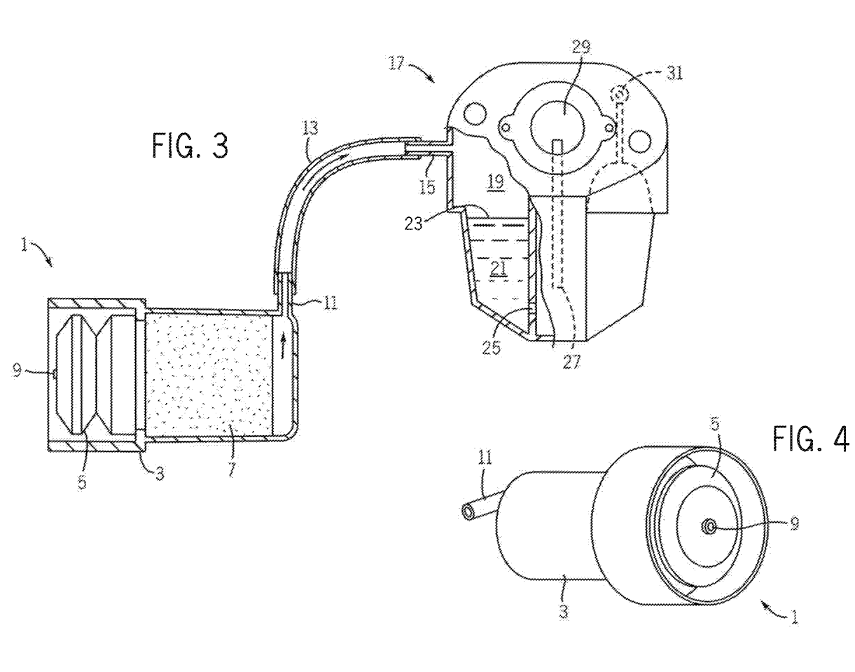

Also mounted upon (and included by) the engine 40 is a primer assembly 54, which includes a link 55 by which the primer assembly is coupled to the fuel bowl 44 (particularly to an upper region of the fuel bowl above the level of fuel within the fuel bowl). In at least some embodiments of the present invention including those shown in FIGS. 1-6, the primer assembly 54 includes a carbon canister therewithin in which hydrocarbons (e.g., fuel fumes) from the fuel bowl 44 (and potentially other components of the engine 40, such as portions of the carburetor 42) are captured, thereby reducing emissions of such hydrocarbons into the outside environment. As discussed below particularly with respect to FIGS. 3-6, the primer assembly 54 can have such a carbon canister integrated into the primer bulb housing. By integrating the carbon canister into the primer bulb housing, this design utilizes fewer components than a separate carbon canister.

To remove the hydrocarbons which are stored in the carbon canister, the primer assembly 54 (particularly the carbon canister) needs to be purged. In at least some embodiments of the present invention, the primer assemblies, and particularly the carbon canisters within the primer assemblies, are actively purged by way of a vacuum created by engine operation. To purge the canister, air needs to be drawn through the carbon. To draw air through the canister, a vacuum source from the carburetor needs to be applied to the carbon canister. Still referring to FIG. 1, as shown in phantom, a variety of venting passageways are possible that allow for communication between the carburetor 42 (and/or associated components) and the primer assembly 54 (and particularly its carbon canister) to allow for active purging of the primer assembly.

A first such venting passageway is an internal vent 56 formed directly within the carburetor 42 leading between the fuel bowl 44 and the inlet 50 (e.g., the upstream end) of the carburetor. As described in further detail with respect to FIGS. 3-6, the inlet 50 can also be considered to constitute part of an air cleaner box that houses the air filter 46, particularly, the region within the air cleaner box that is downstream of the air filter. Purging of the primer assembly 54 by way of the internal vent 56 thus occurs indirectly by way of the fuel bowl 44, to which the link 55 of the primer assembly is coupled. Alternatively, a second such venting passageway involves an external vent (e.g., a link or hose) 58 formed between the inlet 50 and the fuel bowl 44. Such an external vent can also be formed directly between the inlet 50 and the primer assembly 54 (both of which possibilities are intended to be illustrated by FIG. 1, insofar as the vent 58 is shown to proceed into the fuel bowl 44 up to the connecting link 55 of the primer assembly).

Still a third venting passageway is an internal vent 60 formed directly within the carburetor 42 leading between the fuel bowl 44 and the intake manifold 48 (or to the outlet 52 of the carburetor). Again, in this case, purging of the primer assembly 54 by way of the internal vent 60 occurs indirectly by way of the fuel bowl 44. Additionally, a fourth venting passageway is an external vent (e.g., a link or hose) 62 connecting the intake manifold 48 (or the outlet 52 of the carburetor 42) to the fuel bowl 44. Again, as mentioned above with respect to the vent 58, the external vent 62 can also be configured to directly link the intake manifold 48 with the primer assembly 54 (again, both of these possibilities are intended to be illustrated by FIG. 1, insofar as the vent 62 is shown to proceed into the fuel bowl 44 up to the connecting link of the primer assembly).

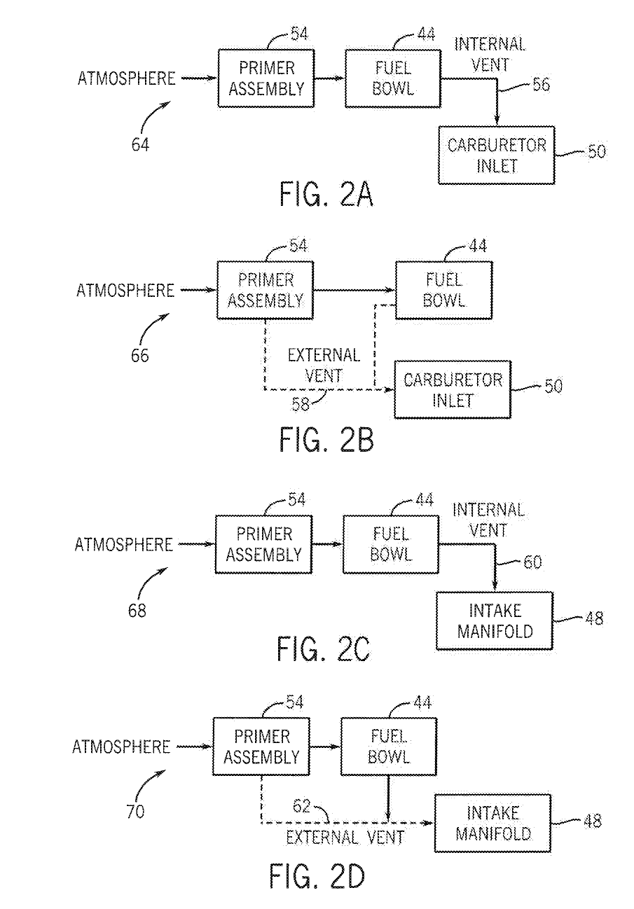

Further referring to FIGS. 2A-2D, first, second, third and fourth flow diagrams 64, 66, 68 and 70 are provided that illustrate various manners of flow of air/gases associated with active purging of the primer assembly 54 by way of the internal and external vents 56, 58, 60 and 62 of FIG. 1, respectively. Purging in particular occurs when the engine 40 is running such that a vacuum or partial vacuum is created. FIG. 2A, which corresponds to purging of the primer assembly 54 by way of the internal vent 56, illustrates how atmospheric air is drawn through the primer assembly 54 (particularly through the carbon canister) such that hydrocarbons within the primer assembly are picked up by that air. Further as shown, the air laden with the hydrocarbons is then drawn into/through the fuel bowl 44 (which also can be referred to as a float bowl or a fuel reservoir), and ultimately into the inlet 50 of the carburetor 40 by way of the internal vent 56, with the fumes entering the carburetor being subsequently combusted into the engine.

FIG. 2B, which corresponds to the purging of the primer assembly 54 by way of the external vent 58, similarly illustrates how atmospheric air is drawn through the primer assembly 54 where hydrocarbons in the primer assembly are picked up by that air. As illustrated, depending upon the configuration of the external vent 58 (e.g., depending upon whether the vent is connected to the fuel bowl 44 or directly to the primer assembly 54) that air including the hydrocarbons then flows from the primer assembly either through the fuel bowl 44 and ultimately into carburetor inlet 50, or directly from the primer assembly, via the external vent 58.

Additionally, FIGS. 2C and 2D respectively correspond to the purging of the primer assembly 54 by way of the internal vent 60 and the external vent 62, respectively. As shown in FIG. 2C, atmospheric air drawn into the primer assembly 54 passes through the primer assembly so as to pick up hydrocarbons, then passes through the fuel bowl 44 and ultimately passes to the intake manifold 48. In contrast, as shown in FIG. 2D, atmospheric air drawn into the primer assembly 54 passes through that assembly so as to pick up hydrocarbons, and then either passes indirectly from that assembly through the fuel bowl 44 and ultimately to the intake manifold 48, or passes directly from that assembly to the intake manifold, depending upon the configuration of the external vent 62.

Although four different configurations are illustrated in FIGS. 1-2D regarding the manner in which the hydrocarbons within the primer assembly 44 are actively purged into/toward the carburetor, other configurations are also possible. For example, in additional alternate embodiments, multiple vents (rather than just a single vent) can be used to link the primer assembly/fuel bowl with the carburetor, carburetor inlet, intake manifold, etc. Also, while the above embodiments envision active purging of the primer assembly 44, in at least some other embodiments of the present invention the primer assembly (particularly its carbon canister) are only passively purged (e.g., where hydrocarbons are merely trapped within the carbon canister but not actively drawn back from the carbon canister into the engine during engine operation). In such embodiments, none of the internal/external vents 56, 58, 60 and 62 or any other similar vents are present.

Referring to FIG. 3, exemplary features of an exemplary embodiment of an actively-purged primer assembly and carburetor (among other components) corresponding to the embodiment of FIG. 2A employing the internal vent 56 are shown in more detail. As shown, the primer assembly 1 comprises a housing 3 in which is inserted a flexible primer bulb 5 and a carbon canister 7. An external vent 9 is located in primer bulb 5 to permit flow of air into the primer bulb 5. Primer bulb 5 is actuated by compressing the bulb such that the distal end, relative to the housing, is forced toward the proximate end. Such compression reduces the volume inside the bulb 5 thereby displacing the air from the bulb 5 into the housing 3. In at least one embodiment, the bulb 5 is compressed by pressure supplied by the operator's finger. Alternatively, the bulb 5 can be compressed by force applied to the distal end by any suitable object. When an operator actuates primer bulb 5, the operator's finger, or other object, covers external vent 9 thereby permitting compression of the primer bulb 5 to force air through the carbon canister 7 and through the subsequently defined channels into the carburetor.

Carbon canister 7 contains a carbon medium, preferably an activated carbon medium. The carbon medium may be in powder, granular, pellet or powder block form, or could be impregnated onto filter media. Carbon canister 7 is adapted to allow air to flow axially from one end of the canister to the other end. Such axial air flow passes over the carbon medium. A conduit 13 provides fluid communication between an outlet stub 11 on the primer assembly housing 1 to an inlet 15 on carburetor 17.

In at least one embodiment, the carburetor is as shown in FIG. 3, although the primer assembly can be used with any suitable carburetor. Inlet 15 of the carburetor 17 is in fluid communication with the fuel bowl 19, and more particularly is in fluid communication with an airspace above fuel 21 residing in the fuel bowl (e.g., an airspace existing above a fuel level 23). When the engine is running, the venturi effect draws fuel 21 through orifice 25 and up through injector 27 to discharge within the fuel air mixing chamber 29. However, when the engine is cold started, a richer fuel air mixture is required. Extra fuel is provided to the mixing chamber 29 by operation of primer bulb 5 which forces air into fuel bowl 19. The air forced into the airspace exerts increased pressure on the surface of fuel level 23 thereby forcing an extra amount of fuel 21 into mixing chamber 29.

Carbon canister 7 serves to capture, by adsorption, fuel vapors from the carburetor and prevent them from leaking to the atmosphere through the external vent 9. During normal operation of the engine, air is drawn in through external vent 9 into the carburetor 17 via the carbon canister 7. The flow of air through carbon canister 7 purges the carbon media of the adsorbed fuel. Consequently, this air flow takes the fuel adsorbed by carbon canister 7 and transports it through channel 13 back to fuel bowl 19 where there it is subsequently drawn through the fuel system into mixing chamber 29. An internal vent 31 connects fuel bowl 19 to the air cleaner cavity. Internal vent 31 helps to draw air through the external vent 9 and increases purging of the activated carbon in the carbon canister. Internal vent 31 also offers some air cleaner restriction compensation. Both inlet 15 and internal vent 31 connect to the fuel bowl in the air cavity above the fuel level 23.

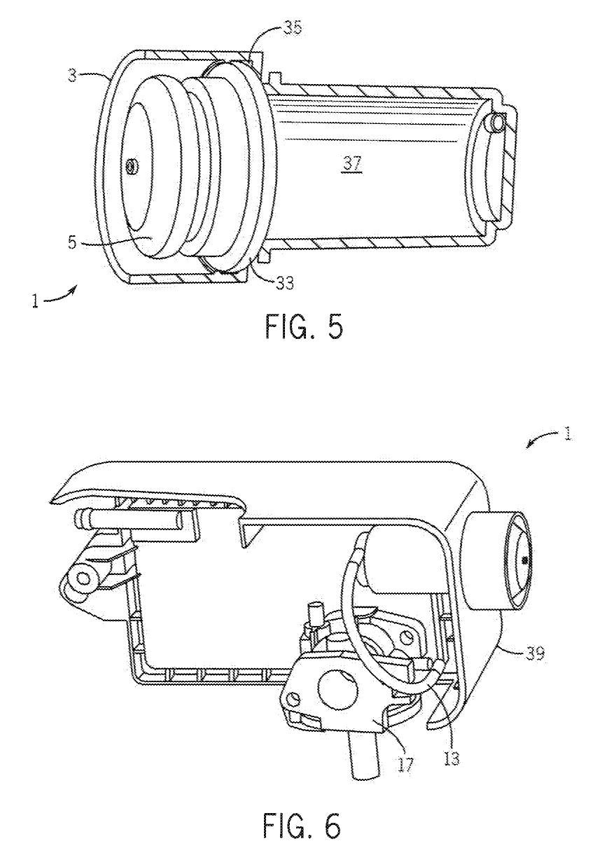

Referring to FIG. 4, the primer assembly 1 is shown from an external view. With primer bulb 5 in place, the only ports into the housing 3 are vent 9 and outlet stub 11. Primer bulb 5 can typically be press-fit into the housing 3, although other means for securing the bulb in place may be used. As shown in FIG. 5, primer bulb 5 has a base rim 33 that can be securely pressed into recess 35 of housing 3. Housing 3 has an internal volume 37 into which the carbon canister 7 (not shown in this view) is placed. Primer bulb 5 seals the open end of housing 3, thereby preventing the carbon canister from being displaced from the housing 3. If a carbon canister needs to be replaced, the primer bulb 5 can be pulled off of housing 3, thereby providing access to the canister.

As for FIG. 6, the primer assembly 1 (with the canister housing 3) is shown to be mounted in an exemplary engine housing 39, which in particular can be considered to form part of an air cleaner box within which is situated an air filter. Although not shown in FIG. 6, in view of the above discussion it will be understood that the internal vent 31 in at least some embodiments links the fuel bowl of the carburetor 17 with a region within the air cleaner box, typically downstream of the air filter within that box.

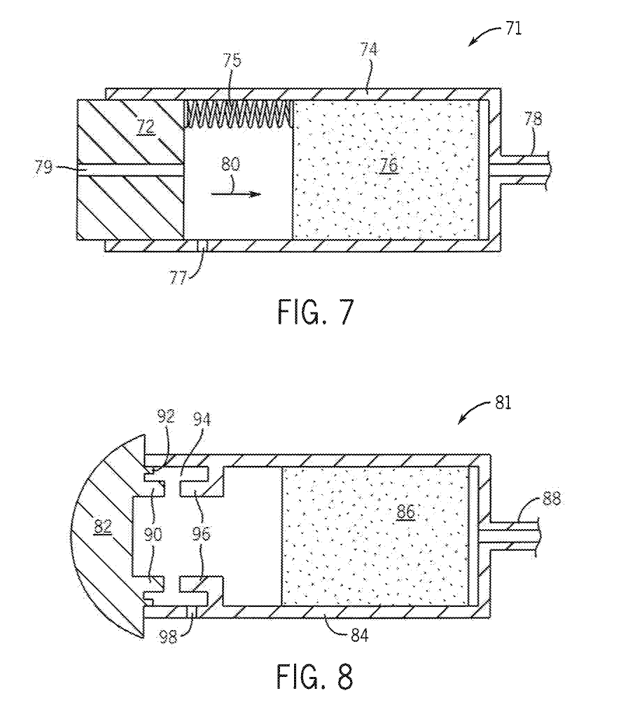

Notwithstanding the above description, the present invention is intended to encompass a variety of alternate embodiments of engines and primer assemblies having a variety of features differing from or in addition to those discussed above. To begin, in at least some other embodiments, the flexible primer bulb is replaced with another volume-displacement structure that, upon being moved, causes displacement of air toward the fuel bowl so as to prime the engine. For example, referring to FIG. 7, an alternate embodiment of a primer assembly 71 can employ, instead of a flexible primer bulb, a piston 72 that is slidably positioned within a housing 74 of the primer assembly that also encloses a carbon canister 76 such that the carbon canister is positioned in between the piston and an outlet 78 that is coupled to the fuel bowl (e.g., by way of a conduit, not shown). As shown, the piston 72 can be biased outward relative to the housing 74 by a biasing device such as a spring 75.

The piston 72 as shown in FIG. 7 has an external vent 79 similar to the external vent 9 described above with respect to the flexible primer bulb 5. That is, the external vent 79 extends generally from a surface of the piston that is internal within the housing 74 when the piston is positioned in the housing (and therefore adjacent/proximate the carbon canister 76 within that housing) to a location positioned along an exterior surface of the piston exposed to the outside environment. While the vent 79 is open and allows for fluid communication between the interior of the housing 74 (including the carbon canister 76) when priming operation is not occurring, the vent 79 is covered and sealed by the operator's finger during priming when the piston 72 is pushed inward into the housing 74 by an operator, such that air can be forced through the carbon canister toward the fuel bowl via the outlet 78 without leakage (or much leakage) out of the vent 79.

Further, in additional alternate embodiments involving either pistons and/or flexible primer bulbs, the external vent need not be a vent that is sealed by the operator's finger. Rather, in such alternate embodiments, the external vent can be a separate passageway that is blocked/sealed in another manner when an operator pushes/actuates the piston or flexible primer bulb (or other volume displacement device). For example, referring still to FIG. 7, in at least some embodiments employing a spring-biased piston, rather than employing the external vent 79, a different external vent 77 is provided that extends through the wall of the housing 74 proximate the end of the housing at which is located the piston, between the piston and the carbon canister 76.

Given appropriate placement of the vent 77, the vent is open and unsealed when the piston is not pressed by an operator and, due to spring-biasing, is at its outermost position relative to the housing 74. This allows communication of air between the outer atmosphere and the interior of the housing, including the carbon canister 76. However, the vent 77 becomes closed and sealed by the piston 72 once the piston is pressed sufficiently inwardly into the housing along the direction indicated by the arrow 80 so as to cover over the vent. After that point, further inward movement of the piston 72 serves to displace air through the carbon canister toward the fuel bowl via the outlet 78, without leakage by way of the vent 77.

Referring to FIG. 8, yet another alternate embodiment of a primer assembly 81 employs a flexible primer bulb 82 supported upon a housing 84 within which is provided a carbon canister 86 between the primer bulb and an outlet 88 by which the primer assembly is coupled to the fuel bowl via a conduit (not shown). In this embodiment, the primer bulb 82 includes an internal lip 90 within the interior of the bulb that is radially-spaced inwardly from an exterior edge 92 of the bulb that is connected to the wall of the housing 84, such that an annular space 94 exists between the lip and the exterior edge. In addition, the housing 84 includes an internal ridge 96 that also extends radially inwardly relative to the wall of the housing, and is configured so as to be contacted by the internal lip 90 of the primer bulb 82 when the bulb moves inwardly into the housing upon being pressed.

Further, the housing 84 includes an external vent 98 through the wall of the housing 84 between the primer bulb 82 and the internal ridge 96. Given this configuration, while the interior of the housing 84 is in communication with the outside environment by way of the external vent 98 when no priming is occurring (that is, when the primer bulb 82 is relaxed), when priming occurs and the primer bulb 82 is pressed by an operator, the internal lip 90 and internal ridge 96 come into contact so as to form a seal, and consequently the vent is sealed off from the remainder of the interior of the housing 84. Further pressing of the primer bulb 82 then serves to force air into the carbon canister 86 toward the fuel bowl via the outlet 88, without leakage by way of the vent 98.

While FIGS. 7 and 8 show certain exemplary alternate embodiments of primer assemblies, the present invention is intended to encompass still additional embodiments of primer assemblies as well. For example, in additional alternate embodiments, more than one external vent can be present (e.g., both of the vents 77 and 79 are present). Indeed, the present invention is intended to encompass a wide variety of primer assemblies that operate in combination with carburetors/fuel bowls of engines. Among other things, the present invention is intended to encompass a wide variety of primer assemblies in which a carbon canister (or other device/mechanism for containing vapors) is positioned in between the engine carburetor/fuel bowl and a primer mechanism, and/or positioned in between the engine carburetor/fuel bowl and one or more external vent(s) (e.g., vent(s) associated with a primer mechanism) such that the carburetor can be externally vented to the outside environment/atmosphere via the carbon canister. In addition, the present invention is intended to encompass a variety of types of primer assemblies in which a carbon canister is integrated with a primer mechanism to form a primer assembly that in turn is coupled to an engine carburetor/fuel bowl. Further, it should be understood that a carbon canister as described herein can take a variety of structural/geometric forms and need not be limited to any particular form (e.g., a cylindrical form).

Further, it should be understood that the present invention is also intended to encompass embodiments of carburetor systems that are externally vented to the outside environment/atmosphere by way of a carbon canister (or other vapor containment device/mechanism for containing vapors), even though no primer mechanism is present and the carbon canister is not part of any primer assembly. For example, the present invention is intended to encompass an alternate embodiment of the embodiment of FIG. 7, where the piston 72 (and the spring 75) are entirely missing, such that the first end of the carbon canister 76 that is opposite to its second end facing the outlet 78 simply faces outward to the environment (since, absent the piston, the housing simply has an open face). Indeed, in a further alternate embodiment, the housing 74 can be entirely dispensed with, assuming that one end of the carbon canister is coupled to the carburetor/fuel bowl. Further, as noted above, the present invention is intended to encompass embodiments (including embodiments not involving any primer mechanism or primer assembly as discussed above) that involve active purging and also embodiments that involve passive purging.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

We claim:

1. A primer assembly comprising:
a housing comprising an open end and an outlet; a primer actuation mechanism inserted into and closing the open end of the housing, thereby defining a volume within the housing;
a vapor containment element positioned within the volume defined in the housing; and,
a vent formed within either the housing or the primer actuation mechanism, wherein the vent leads between the volume and a region external of the housing, wherein the vent and the outlet are in fluid communication via a flow path that extends through the vapor containment element.

2. The assembly of claim 1, wherein the primer actuation mechanism includes a flexible primer bulb, wherein the primer bulb is adapted to be compressed such that air is forced from within the primer bulb through the vapor containment element and the outlet.

3. The assembly of claim 2, wherein the housing comprises a recess that extends around an inner surface of the open end, the primer bulb comprises a base rim adapted to interact with the recess and the primer bulb is inserted into the open end such that the base rim is secured within the recess.

4. The assembly of claim 2, vent is on a distal end, in relation to the housing, of the primer bulb, and wherein the vent is configured so as to be sealed when an external object closes the vent during compression of the primer bulb, the primer bulb being compressed by the action of an external object against the distal end of the primer bulb

5. The assembly of claim 2, wherein the vent is formed within and extends through a wall of the housing that also includes an internal ridge, and wherein the primer bulb includes an internal lip that comes into contact with the internal ridge when the primer bulb is pressed, thereby sealing off the vent from a portion of the volume.

7. The assembly of claim 1, wherein the primer actuation mechanism includes a piston slidably disposed within the housing, wherein the piston is configured so that, when pushed inward into the housing, air within the housing is forced through the canister and the outlet.

8. The assembly of claim 7, wherein the vent is formed within either the piston or a wall of the housing.

9. The assembly of claim 1, further comprising a conduit providing fluid communication between the outlet and a carburetor.

10. The assembly of claim 1, wherein vapor containment element includes a carbon canister.

11. The assembly of claim 10, wherein the carbon canister includes an activated carbon media.

12. A carburetor priming system comprising:
a carburetor adapted to introduce fuel into air that is being drawn into an engine such that a predetermined fuel to air ratio is maintained, the carburetor being further adapted to introduce an extra amount of fuel into the air, such that the fuel to air ratio is higher than the predetermined ratio, in response to the action of a primer;
a primer assembly comprising a housing comprising an open end and an outlet, a primer actuation mechanism inserted into and closing the open end of the housing, thereby defining a volume within the housing, a vapor containment device positioned within the volume defined in the housing, and a vent extending through either the primer actuation mechanism or the housing, wherein the vent and the outlet are in fluid communication via a flow path that extends through the vapor containment device; and,
a conduit providing fluid communication between the outlet and the airspace above a fuel level in a reservoir of fuel associated with the carburetor.

13. The system of claim 12, wherein the carburetor comprises a throat through which air is drawn into an engine, wherein the fuel reservoir is substantially enclosed and is adapted to be partially full during operation of the engine such that fuel in the reservoir fills the reservoir to the fuel level, and wherein a nozzle extends from below the fuel level in the reservoir to the throat such that fuel is transferred from the reservoir to the throat by means of a venturi effect when air passes through the throat.

14. The system of claim 12, wherein the carburetor priming system includes at least one vent providing fluid communication between the airspace above the fuel level and a region at or upstream of a carburetor inlet or at or downstream of a carburetor outlet.

15. The system of claim 14, wherein the region is either a region downstream of an air filter of an air cleaner and an intake manifold.

16. The system of claim 14, wherein the vent is formed substantially within at least one wall of the carburetor.

17. The system of claim 14, wherein the vent includes at least one external conduit.

18. The system of claim 12, wherein the primer actuation mechanism includes a flexible primer bulb.

19. The system of claim 18, wherein the housing comprises a recess that extends around an inner surface of the open end, wherein the primer bulb comprises a base rim adapted to interact with the recess and the primer bulb is inserted into the open end such that the base rim is secured within the recess, wherein the vent is on a distal end, in relation to the housing, of the primer bulb, and wherein the primer bulb is adapted to be compressed such that air is forced from within the primer bulb through the canister and the outlet.

20. The system of claim 18, wherein the primer bulb is compressed by the action of an external object against a distal end of the primer bulb, and wherein the external object closes the vent during compression of the primer bulb.

21. The system of claim 12, wherein the primer actuation mechanism includes a piston.

22. The system of claim 12, further comprising a conduit providing fluid communication between the outlet and a carburetor.

23. The system of claim 12, wherein the vapor containment device includes a carbon canister comprises an activated carbon media.

24. A method for reducing fuel emissions from a carburetor that is externally vented through a primer, the method comprising:
providing a primer assembly comprising a housing comprising an open end and an outlet, a primer actuation mechanism inserted into and closing the open end of the housing, thereby defining a volume within the housing, a vapor containment element positioned within the volume defined in the housing, and a vent extending through either the primer actuation mechanism or the housing, wherein the vent and the outlet are in fluid communication via a flow path that extends through the vapor containment element;
connecting the primer in fluid communication with the carburetor such that fuel vapors from the carburetor enter the vapor containment element; and
adsorbing the fuel vapors in the vapor containment element.

25. The method of claim 24, further comprising allowing air to flow through the vapor containment element from the vent to either the carburetor or a region in communication with the carburetor, such that the air flowing through the vapor containment element purges the vapor containment element of at least some of the fuel adsorbed by the vapor containment element.

26. The method of claim 25, wherein the air flowing through the vapor containment element to either the carburetor or the region in communication with the carburetor occurs by way of at least one of the following: (a) an internal vent at least indirectly linking the vapor containment element with a region upstream of the carburetor; (b) an internal vent at least indirectly linking the vapor containment element with a region downstream of the carburetor; (c) an external passageway at least indirectly linking the vapor containment element with a region upstream of the carburetor; and (d) an external passageway at least indirectly linking the vapor containment element with the region downstream of the carburetor.

27. The method of claim 26, wherein the region upstream of the carburetor is a region within an air cleaner box downstream of an air filter, and wherein the region downstream of the carburetor is an intake manifold.

28. The method of claim 24, wherein the primer actuation mechanism includes either a flexible primer bulb or a piston.

29. A carburetor system comprising:
a carburetor;
a fuel bowl having an airspace above a fuel level, wherein the airspace is coupled to the carburetor for communication of vapors therebetween by way of a first channel;
a vapor containment device having first and second ports; and
a second channel linking the first port of the vapor containment device at least indirectly to the airspace for further communication of the vapors between the fuel bowl and the vapor containment device,
wherein the second port of the vapor containment device is in direction communication with an external environment outside of the carburetor system.

30. The carburetor system of claim 29, wherein the vapor containment device is either actively purged or passively purged.
